(19) United States
(12) Patent Application Publication
(10) Pub. No.: US 2023/0026571 A1
(43) Pub. Date: Jan. 26, 2023

(54) THERMAL SENSOR PACKAGE

(71) Applicant: LITE-ON SINGAPORE PTE. LTD., Singapore (SG)

(72) Inventors: YU-HSIEN LIU, Taipei City (TW); Suresh Basoor Nijaguna, SINGAPORE (SG); QIAN PANG, Jiamusi (CN); I-CHEN CHIEN, Keelung City (TW)

(21) Appl. No.: 17/567,984

(22) Filed: Jan. 4, 2022

(30) Foreign Application Priority Data
Jul. 23, 2021 (CN) 202110835755.3

(51) Int. Cl. G01J 5/12

(52) U.S. Cl. CPC G01J 5/12

(57) ABSTRACT

A thermal sensor package is provided. The thermal sensor package includes a carrier, an integrated circuit chip (IC), an adhesive, a thermal sensor, and a cover that are stacked form bottom to top. The carrier defines a space. The IC and thermal sensor are arranged in the space. At least one part of the adhesive is disposed between the thermal sensor and the IC. The cover closes the space defined by the carrier.

### CROSS-REFERENCE TO RELATED PATENT APPLICATION

This application claims the benefit of priority to China Patent Application No. 202110835755.3, filed on Jul. 23, 2021 in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a sensor package, and more particularly to a thermal sensor package.

### BACKGROUND OF THE DISCLOSURE

An infrared temperature sensor is used for absorbing thermal radiation (e.g., infrared) generated by an object to be tested, so as to obtain a temperature thereof. Accordingly, the infrared temperature sensor is widely used in ear thermometers, proximity sensors, thermal imaging devices, etc. However, product miniaturization has become an inevitable trend in the market. Therefore, how to improve a structural design, so as to reduce a package size without affecting measurement accuracy and within a limited manufacturing cost, has become one of the important issues to be addressed in the related art.

### SUMMARY OF THE DISCLOSURE

In response to the above-referenced technical inadequacy, the present disclosure provides a thermal sensor package of which a volume can be effectively reduced after packaging.

In one aspect, the present disclosure provides a thermal sensor package, which includes a carrier, an integrated circuit chip (IC), an adhesive, a thermal sensor, and a cover that are stacked from bottom to top.

Therefore, one of the beneficial effects of the present disclosure is that, in the thermal sensor package provided by the present disclosure, the thermal sensor and the IC are arranged along a thickness direction of a base of the carrier, so that a size of the carrier can be reduced. Further, a size of an integrated package of the thermal sensor and the IC can be reduced, and a degree of integration of the integrated package can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of a first embodiment of a thermal sensor package;

FIG. 2 is a top view of the thermal sensor package according to the first embodiment of the present disclosure;

FIG. 3 is a cross-sectional view taken along line III-III of FIG. 2;

FIG. 4A is an exploded perspective view of a thermal sensor according to one embodiment of the present disclosure;

FIG. 4B is a partial cross-sectional view of a thermopile layer according to one embodiment of the present disclosure;

FIG. 5 to FIG. 8 are cross-sectional views showing the thermal sensor package in different stages of a manufacturing process according to the first embodiment of the present disclosure;

FIG. 9A is a perspective view of a thermal sensor package according to a second embodiment of the present disclosure;

FIG. 9B is a cross-sectional view of the thermal sensor package according to the second embodiment of the present disclosure;

FIG. 10 is a cross-sectional view of a thermal sensor package according to a third embodiment of the present disclosure;

FIG. 11 is a top view of a thermal sensor package according to a fourth embodiment of the present disclosure;

FIG. 12 is a cross-sectional view taken along line XII-XII of FIG. 11; and

FIG. 13 is a partial view of the thermal sensor according to another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

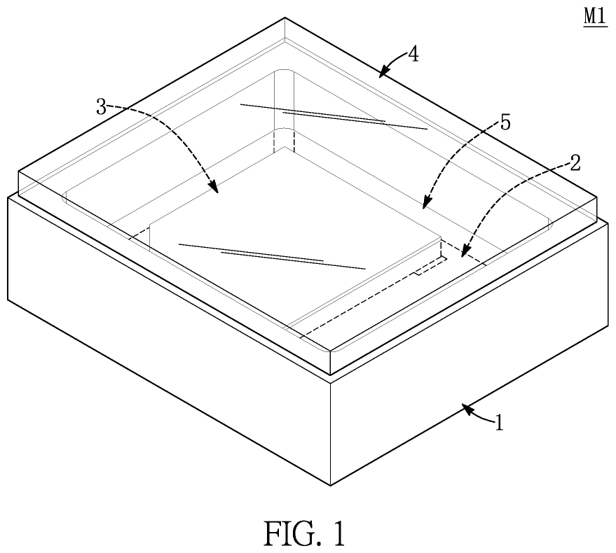

Referring to FIG. 1 to FIG. 3, FIG. 1 to FIG. 3 respectively show a perspective view, a top view, and a cross-sectional view of a thermal sensor package according to a first embodiment of the present disclosure. The first embodiment of the present disclosure provides a thermal sensor package M1, which includes a carrier 1, an integrated circuit within a silicon chip (IC) 2, a thermal sensor 3, a cover 4, and a thermally conductive insulating adhesive 5 (hereinafter “the adhesive 5”).

The carrier 1 can define a space H1 and an opening (not labeled). In the present embodiment, the carrier 1 has a base 10 and a side wall 11. The base 10 can be a flat plate, or the base 10 can have a recess or a stepped structure. When the base 10 has the recess, the recess can be used for accommodating the IC 2, and a depth of the recess is equal to or slightly less than a height of the IC 2. The base 10 having the recess contributes to miniaturization of an overall structure. In one particular embodiment, the base 10 can be a multi-layer circuit board. The side wall 11 is surroundingly arranged on the base 10, and the side wall 11 and the base 10 jointly define the space H1. That is to say, the side wall 11 protrudes from the base 10, and surrounds the IC 2 and the thermal sensor 3. In the present embodiment, the base 10 and the side wall 11 are integrally formed. That is to say, the base 10 and the side wall 11 are made of the same material (e.g., a stacked ceramic layer), but the present disclosure is not limited thereto.

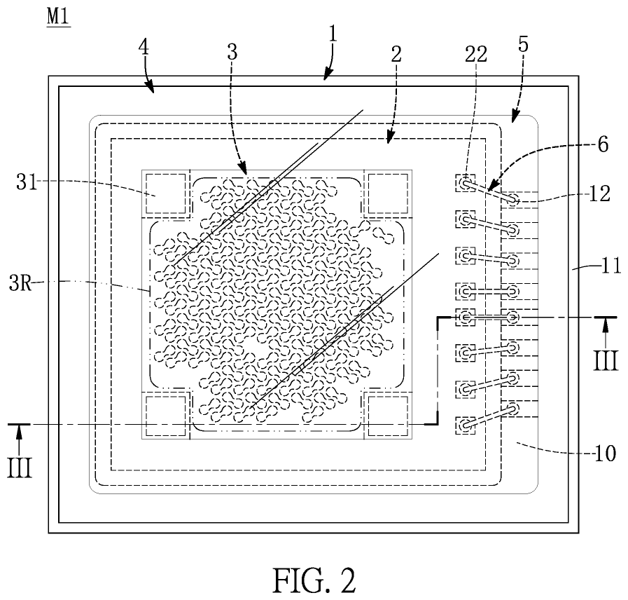

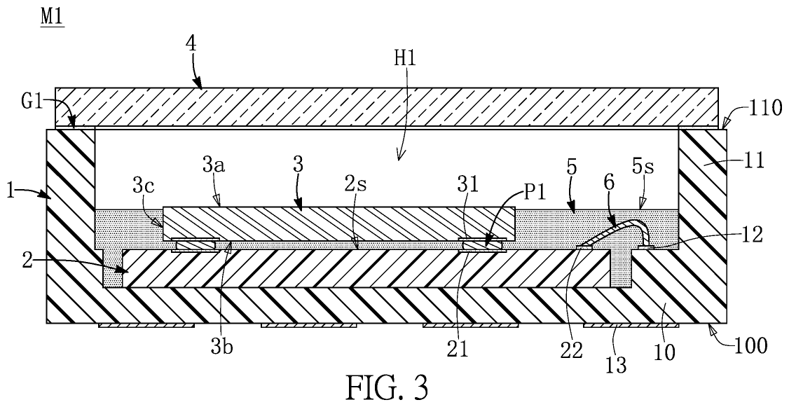

Referring to FIG. 2 and FIG. 3, the carrier 1 further includes a plurality of internal contacts 12 and a plurality of external contacts 13. The plurality of internal contacts 12 are arranged in the space H1 and on the base 10. When the base 10 is the flat plate, the plurality of internal contacts 12 are arranged on a surface of the flat plate. When the base 10 has the recess or the stepped structure, the plurality of internal contacts 12 are preferably arranged on a top surface of the recess or the stepped structure (that is, where the base 10 is connected to the side wall 11). Further, a height of a top surface of the base 10 is similar to a height of an upper surface 2s of the IC 2 arranged in the recess or the stepped structure. Accordingly, a distance of wire bonding can be reduced so that stress can be reduced to prevent wire breakage, but the present disclosure is not limited thereto. In addition, in the present embodiment, the plurality of external contacts 13 are arranged on a bottom side of the carrier 1 (that is, on a bottom surface 100 of the base 10). In this way, the thermal sensor package M1 can be assembled onto another circuit board (not shown in the figures) through the plurality of external contacts 13. However, in the present disclosure, the position of the plurality of external contacts 13 is not limited to the aforementioned examples.

It should be noted that, a plurality of lines (not shown in the figures) can be pre-formed in the base 10 or the side wall 11 of the carrier 1, so that each of the plurality of internal contacts 12 of the carrier 1 can be electrically connected to at least a corresponding one of the plurality of external contacts 13.

Referring to FIG. 2 and FIG. 3, the IC 2 is arranged in the space H1 and on the base 10. The IC 2 is an application-specific integrated circuit (ASIC) chip that can be used to receive and process a signal detected by the thermal sensor 3. The signal is, for example, a voltage signal. Further, the IC 2 can calculate a temperature of an object based on the received signal. In the present embodiment, the IC 2 includes a plurality of first connection pads 21 and a plurality of second connection pads 22. The plurality of first connection pads 21 and the plurality of second connection pads 22 are arranged on the upper surface 2s of the IC 2. The plurality of first connection pads 21 are arranged at a position corresponding to the thermal sensor 3, and are used for electrically connecting the IC 2 to the thermal sensor 3. In the present embodiment, the plurality of first connection pads 21 are arranged underneath the thermal sensor 3. In addition, the IC 2 can be electrically connected to the carrier 1 through the plurality of second connection pads 22. More specifically, the thermal sensor package M1 further includes a plurality of conducting wires 6, and each of the plurality of conducting wires 6 is connected between a corresponding one of the plurality of second connection pads 22 and a corresponding one of the plurality of internal contacts 12. In other words, the plurality of second connection pads 22 correspondingly are electrically connected to the plurality of internal contacts 12 of the carrier 1 through the plurality of conducting wires 6. Further, the plurality of second connection pads 22 arranged on the upper surface 2s of the IC 2 and the plurality of internal contacts 12 arranged on the top surface of the base 10 are of a similar height or flush with each other, such that the distance of wire bonding can be reduced and wire breakage can be prevented.

The thermal sensor 3 is stacked on the IC 2, and the thermal sensor 3 and the IC 2 are jointly arranged in the space H1 for receiving thermal radiation entering from the opening. In the present embodiment, the thermal sensor 3 can be an infrared thermopile sensor, but the present disclosure is not limited thereto. Accordingly, the thermal sensor 3 of the present embodiment has a heat absorbing surface 3a, a bottom surface 3b that is opposite to the heat absorbing surface 3a, and a side surface 3c connected between the heat absorbing surface 3a and the bottom surface 3b. Further, the heat absorbing surface 3a of the thermal sensor 3 is made of an infrared absorbing material, which can be used for receiving thermal radiation from an object to be tested.

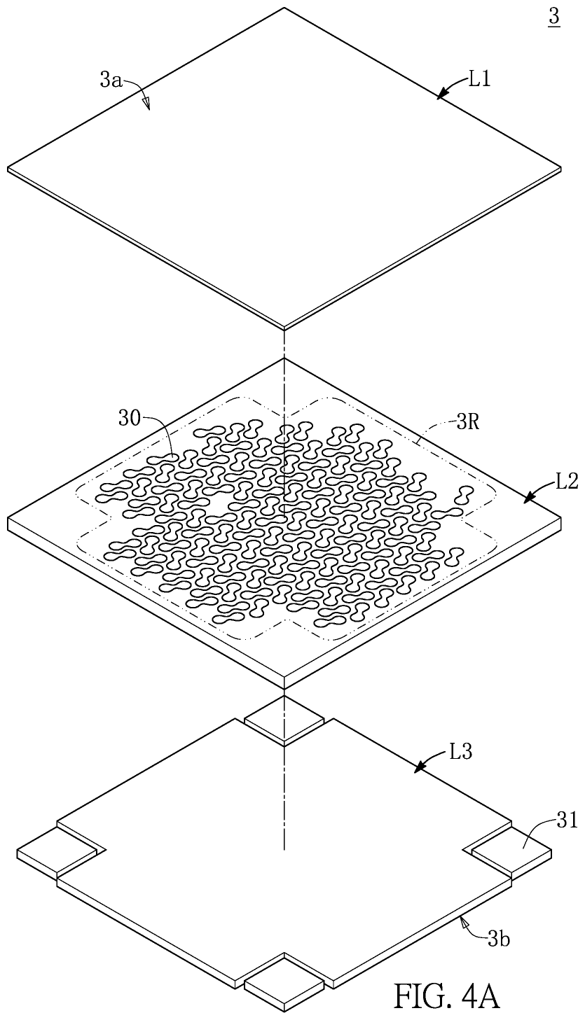

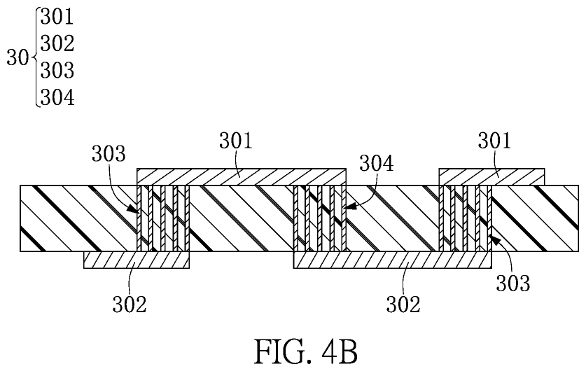

Referring to FIG. 2 and FIG. 4A, FIG. 4A is an exploded perspective view of the thermal sensor according to one embodiment of the present disclosure. The thermal sensor 3 includes an infrared radiation absorbing layer L1, a thermopile layer L2, a protective layer L3, and a plurality of pads 31 (four of the plurality of pads 31 are shown in FIG. 4A as an example).

The infrared radiation absorbing layer L1 can be used for absorbing the thermal radiation, and the aforementioned heat absorbing surface 3a is a surface of the infrared radiation absorbing layer L1. The infrared radiation absorbing layer L1 absorbs more than 90% of infrared light. In one particular embodiment, the infrared radiation absorbing layer L1 absorbs radiation within a wavelength range from 250 nm to 22.5 μm. In addition, a material of the infrared radiation absorbing layer L1 not only absorbs the infrared light but also has flexibility.

The thermopile layer L2 is arranged between the infrared radiation absorbing layer L1 and the protective layer L3. Referring to FIG. 4A and FIG. 4B, FIG. 4B is a partial cross-sectional view of the thermopile layer according to one embodiment of the present disclosure. As shown in FIG. 4A, the thermopile layer L2 includes a plurality of thermocouples 30 that are distributed in a sensing area 3R and connected in series with each other. As shown in FIG. 4B, each of the plurality of thermocouples 30 include a hot junction 301, a cold junction 302, a first pin assembly 303, and a second pin assembly 304. In the present embodiment, the hot junction 301 is closer to the heat absorbing surface 3a, while the cold junction 302 is closer to the bottom surface 3b. The hot junction 301 of one of the plurality of thermocouples 30 is connected in series to the cold junction 302 of another one of the plurality of thermocouples 30 that is adjacent to the one of the plurality of thermocouples 30 at least through the first pin assembly 303 or the second pin assembly 304. In the present embodiment, each of the first pin assembly 303 and the second pin assembly 304 includes a plurality of nanowire clusters. The plurality of nanowire clusters of the first pin assembly 303 and the plurality of nanowire clusters of the second pin assembly 304 are made of two materials that are different from each other. The plurality of thermocouples 30 can be connected in series to each other to form a thermopile, such that a difference between a temperature detected by the hot junctions 301 and a temperature detected by the cold junctions 302 can be converted into the voltage signal or a current signal.

Referring to FIG. 3 and FIG. 4A, the protective layer L3 and the plurality of pads 31 of the thermal sensor 3 are jointly arranged on a bottom side of the thermal sensor 3. As shown in FIG. 4A, the protective layer L3 covers the plurality of thermocouples 30 within the sensing area 3R, but does not cover the plurality of pads 31. That is to say, the plurality of pads 31 are exposed on the bottom surface 3b of the thermal sensor 3, and are respectively arranged near four corners of the thermal sensor 3. A quantity and a position of the plurality of pads 31 can be adjusted according to a type of the thermal sensor 3, which is not limited in the present disclosure. It should be noted that, two of the plurality of pads 31 are electrically connected to the thermopile, so as to be used as a signal output terminal of the thermopile.

Referring again to FIG. 3, the thermal sensor 3 is arranged on the IC 2 with the bottom surface 3b facing the IC 2. More specifically, the plurality of pads 31 of the thermal sensor 3 are respectively and electrically connected to the plurality of first connection pads 21 of the IC 2. Further, the plurality of pads 31 of the thermal sensor 3 are connected to the plurality of first connection pads 21 respectively through a plurality of electrically conductive adhesives P1. In one particular embodiment, the electrically conductive adhesive P1 can be silver paste, so as to reduce cost and processing difficulty.

It should be noted that, in the thermal sensor package M1 provided by the embodiments of the present disclosure, the thermal sensor 3 is stacked on the IC 2, instead of being arranged side-by-side with the IC 2 and disposed directly on the base 10. That is to say, the thermal sensor 3 and the IC 2 are arranged along a thickness direction of the base 10. Therefore, a size of the base 10 of the carrier 1 can be reduced, thereby reducing an overall volume of the thermal sensor package M1.

In continuation of the above, after the infrared radiation absorbing layer L1 of the thermal sensor 3 absorbs the thermal radiation generated by the object to be tested, a temperature of the infrared radiation absorbing layer L1 increases, so that there is a temperature difference between the hot junctions 301 and the cold junctions 302 of the plurality of thermocouples 30, thereby generating the voltage signal. The voltage signal can be outputted to the IC 2 through the two of the plurality of pads 31. After receiving and processing the voltage signal, the IC 2 can calculate a temperature of the object to be tested according to a comparison table or a formula.

In the present embodiment, a gap is defined between the bottom surface 3b of the thermal sensor 3 and the IC 2. When the thermal sensor 3 is an infrared thermopile sensor, if the gap between the thermal sensor 3 and the IC 2 is filled with air, a temperature distribution on the bottom surface 3b of the thermal sensor 3 may be uneven, or a large difference is created between a temperature of the bottom surface 3b of the thermal sensor 3 and a temperature of the IC 2, thereby affecting measurement accuracy of the thermal sensor 3.

Referring to FIG. 3, in the present embodiment, the thermal sensor package M1 further includes the adhesive 5 arranged in the space H1. The adhesive 5 has good thermal conductivity but electrically insulating adhesive. At least a part of the adhesive 5 is filled into the gap between the thermal sensor 3 and the IC 2, so as to form a so-called underfill. Due to formation of the underfill, a bonding strength of the pads of the thermal sensor 3 and the IC 2 can be effectively increased, and the temperature distribution on the bottom surface 3b of the thermal sensor 3 can also be more even. In addition, the temperature of the thermal sensor 3 is roughly the same as the temperature of the IC 2, thereby reducing a signal-to-noise ratio and improving sensing accuracy of the thermal sensor package M1. In an exemplary embodiment, the thermal conductivity of the adhesive 5 is greater than or equal to 1 W/m*K. A material of the adhesive 5 is, for example, epoxy resin or silicone, which may include oxide particles such as zinc oxide, but the present disclosure is not limited thereto.

After actual testing, a temperature error of measurement of the thermal sensor package M1 ranges from −0.5° C. to 0.5° C. when the adhesive 5 having the thermal conductivity greater than or equal to 1 W/m*K is used. If an adhesive material having the thermal conductivity less than 1 W/m*K is used or if the adhesive 5 is not used, the temperature error of the measurement of the thermal sensor package M1 ranges from −1° C. to 1° C. Accordingly, in the embodiments of the present disclosure, using the adhesive 5 having the thermal conductivity greater than or equal to 1 W/m*K can further improve the measurement accuracy of the thermal sensor package M1.

In addition, since the heat absorbing surface 3a of the thermal sensor 3 is used for receiving the thermal radiation from the object to be tested, the adhesive 5 does not cover the heat absorbing surface 3a of the thermal sensor 3, so as not to affect an operation of the thermal sensor 3 (which can affect the measurement accuracy of the thermal sensor 3). Accordingly, a top surface 5s of the adhesive 5 is lower than or flush with the heat absorbing surface 3a of the thermal sensor 3. Further, the adhesive 5 completely covers the IC 2 and partially covers the side surface 3c of the thermal sensor 3.

In addition, referring to FIG. 2 and FIG. 3, the adhesive 5 of the present embodiment further covers the plurality of internal contacts of the carrier 1, the plurality of conducting wires 6, and the plurality of second connection pads 22 of the IC 2. Accordingly, referring to FIG. 2, from a top view, the adhesive 5 extends beyond an edge of the thermal sensor 3 and an edge of the IC 2. However, the present disclosure is not limited thereto. In one particular embodiment, as long as the adhesive 5 fills the gap between the thermal sensor 3 and the IC 2, and a distribution of the adhesive 5 is larger than and overlaps with the sensing area 3R of the thermal sensor 3, the measurement accuracy of the thermal sensor package M1 can be improved.

Referring to FIG. 2 and FIG. 3, the cover 4 is connected to the carrier 1, and is arranged at a position corresponding to the opening so as to close the space H1. As shown in FIG. 3, in the present embodiment, the cover 4 is arranged on a top surface 110 of the side wall 11 of the carrier 1, so as to pack the thermal sensor 3 and the IC 2 together in the space H1 in an airtight manner. The cover 4 can be fixed to the top surface 110 of the side wall 11 through a bonding layer G1. In one particular embodiment, the space H1 can also be filled with nitrogen or other inert gases.

The cover 4 can be made of an infrared band-pass filter, such as a material that allows infrared light within a wavelength range from 1 μm to 15 μm to pass through, but filters visible light. For example, the material of the cover 4 can be silicon, germanium, a silicon-germanium substrate with an infrared optical coating layer, sapphire, quartz glass, etc., but the present disclosure is not limited thereto. In this way, the thermal radiation (i.e., the infrared light) generated by the object to be tested can be absorbed by the thermal sensor 3 through the cover 4.

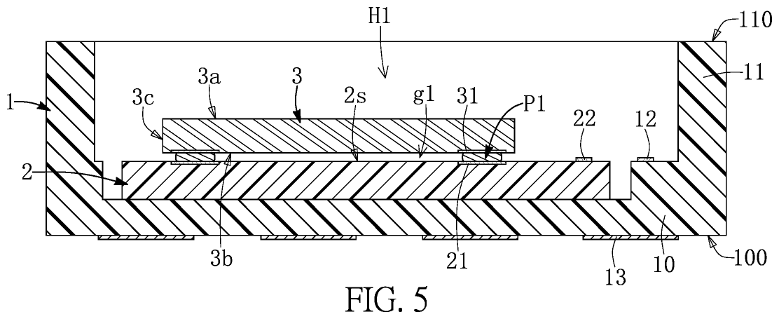

Referring to FIG. 5 to FIG. 8, FIG. 5 to FIG. 8 are cross-sectional views showing the thermal sensor package in different stages of a manufacturing process according to the first embodiment of the present disclosure.

Referring to FIG. 5, after the IC 2 is disposed on the base 10 of the carrier 1, the thermal sensor 3 is disposed on the upper surface 2s of the IC 2. The upper surface 2s of the IC 2 includes the plurality of first connection pads 21 and the plurality of second connection pads 22. In one particular embodiment, the plurality of first connection pads 21 and the plurality of second connection pads 22 can be formed by a screen printing process, but the present disclosure is not limited thereto. Then, the plurality of pads 31 of the thermal sensor 31 are respectively and electrically connected to the corresponding plurality of first connection pads 21 through the plurality of electrically conductive adhesives P1. A gap g1 is defined between the thermal sensor 3 and the IC 2.

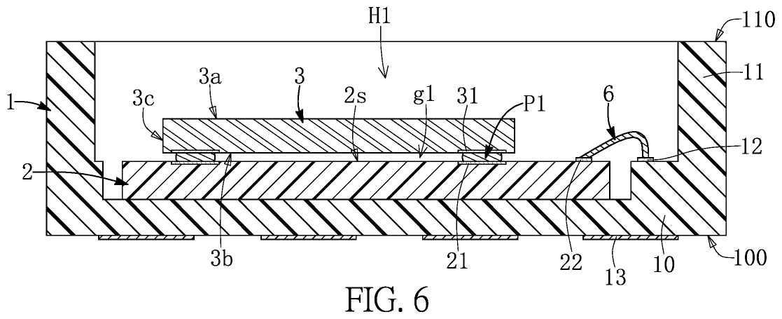

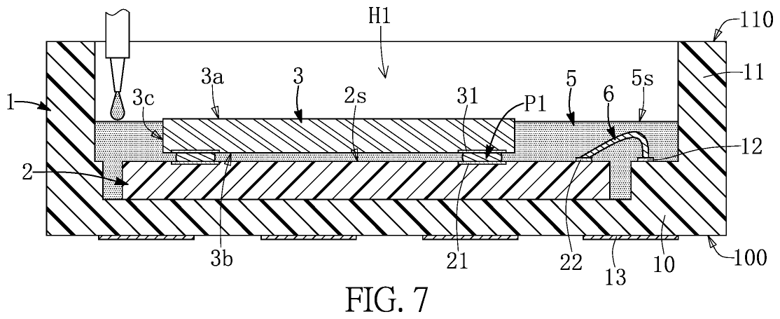

Referring to FIG. 6, the IC 2 is electrically connected to the carrier 1 by wire bonding. More specifically, the plurality of second connection pads 22 of the IC 2 are correspondingly connected to the plurality of internal contacts 12 through the plurality of conducting wires 6. Referring to FIG. 7, the adhesive 5 is formed in the space H1, so that a part of the adhesive 5 is filled into the gap g1 between the thermal sensor 3 and the IC 2. More specifically, the adhesive 5 that is uncured is first filled in the space H1, and then the adhesive 5 is cured by heating. In the present embodiment, the adhesive 5 covers the plurality of second connection pads 22, the plurality of conducting wires 6, and the plurality of internal contacts 12 together. However, the adhesive 5 does not cover the heat absorbing surface 3a of the thermal sensor 3. Therefore, the adhesive 5 does not fill the space H1 entirely.

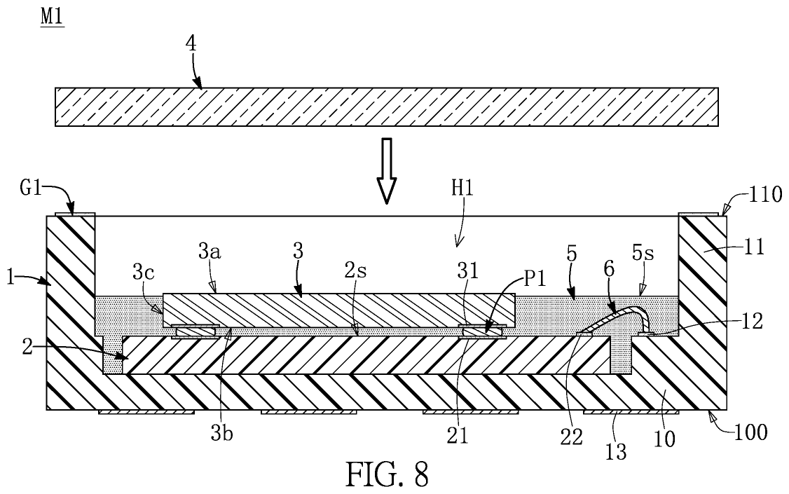

Referring to FIG. 8, the cover 4 is fixed to the carrier 1, so as to close the space H1. Further, the cover 4 can be fixed to the top surface 110 of the side wall 11 of the carrier 1 through the bonding layer G1. However, the manufacturing process described above is merely an example, and is not meant to limit the scope of the present disclosure.

### Second Embodiment

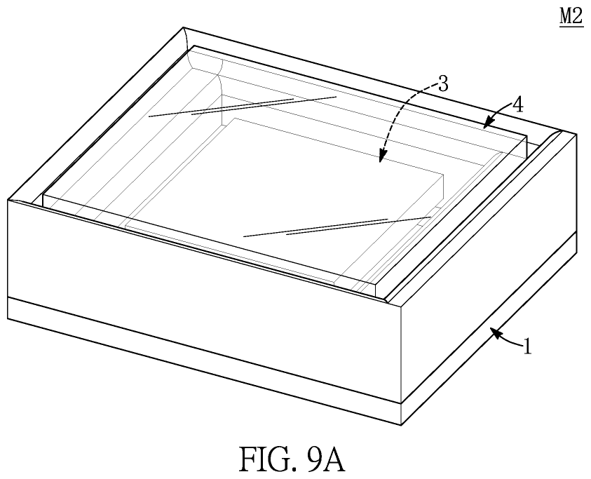

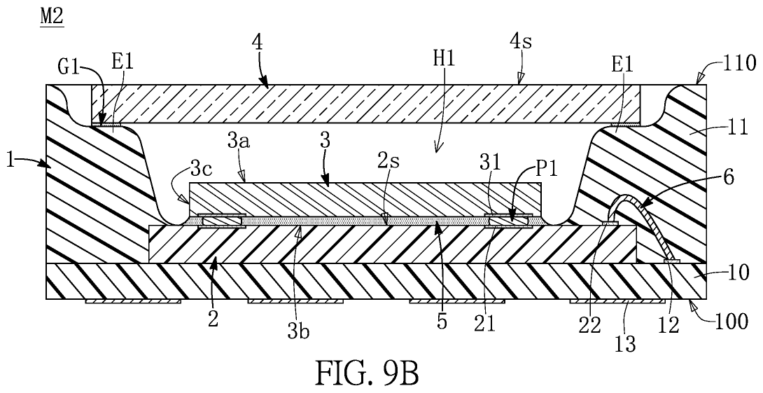

Referring to FIG. 9A and FIG. 9B, FIG. 9A and FIG. 9B are respectively a perspective view and a cross-sectional view of a thermal sensor package according to a second embodiment of the present disclosure. In the present embodiment, components of a thermal sensor package M2 that are the same as or similar to those of the thermal sensor package M1 of the first embodiment have the same or similar markings, and the same components will not be reiterated herein.

As shown in FIG. 9A and FIG. 9B, in the carrier 1 of the thermal sensor package M2 of the present embodiment, the base 10 and the side wall 11 are not integrally formed, but are each made of a different material. For example, the base 10 can be made of ceramic or a circuit board, and the side wall 11 can be made of plastic sealing materials (such as epoxy resin or plastic sealant). In the present embodiment, the base 10 is the flat plate, and the plurality of internal contacts 12 are arranged on the surface of the flat plate.

In addition, in the present embodiment, the side wall 11 covers the base 10 and partially covers the IC 2. As shown in FIG. 9B, a part (i.e., a peripheral area) of the upper surface 2s and a side surface of the IC 2 are covered by the side wall 11. Moreover, the side wall 11 of the present embodiment further covers the plurality of conducting wires 6, the plurality of second connection pads 22 of the IC 2, and the plurality of internal contacts 12 of the carrier 1. In other words, the plurality of conducting wires 6, the plurality of second connection pads 22 of the IC 2, and the plurality of internal contacts 12 of the carrier 1 are embedded in the side wall 11. The side wall 11 is surroundingly arranged on a periphery of the thermal sensor 3, so as to define the space H1 and the opening.

As shown in FIG. 9A and FIG. 9B, the side wall 11 also has an engagement structure E1, and the engagement structure E1 is arranged on a side of the side wall 11 that is away from the base 10. In the present embodiment, the engagement structure E1 is formed on the top surface 110 of the side wall 11, i.e., at an end where the opening is located. In this way, the cover 4 can be arranged above the thermal sensor 3 through the engagement structure E1. Further, the cover 4 can be engaged with the side wall 11 through the engagement structure E1, so as to pack the thermal sensor 3 and the IC 2 together in the space H1 in an airtight manner. In the present embodiment, the engagement structure E1 of the side wall 11 is a stepped structure, and the cover 4 can be bonded to the engagement structure E1 through the bonding layer G1.

In the present embodiment, a top surface 4s of the cover 4 is flush with the top surface 110 of the side wall 11, but the present disclosure is not limited thereto. In another embodiment, the top surface 4s of the cover 4 can be higher or lower than the top surface 110 of the side wall 11.

In addition, the adhesive 5 is filled into the gap between the thermal sensor 3 and the IC 2. However, in the present embodiment, the adhesive 5 covers only a part of the upper surface 2s of the IC 2, but does not cover the side surface of the IC 2.

Accordingly, in the manufacturing process of the thermal sensor package M2 of the present embodiment, the IC 2 and the thermal sensor 3 are sequentially disposed on the base 10, and then the side wall 11 is formed by injection molding. In one particular embodiment, the side wall 11 can be formed by film assisted injection molding, but the present disclosure is not limited thereto.

### Third Embodiment

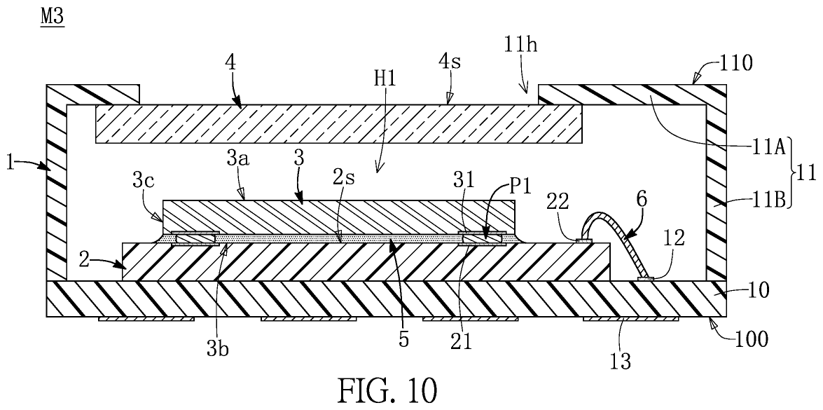

Referring to FIG. 10, FIG. 10 is a cross-sectional view of a thermal sensor package according to a third embodiment of the present disclosure. In the present embodiment, components of a thermal sensor package M3 that are the same as or similar to those of the thermal sensor package M2 of the second embodiment have the same or similar markings, and the same components will not be reiterated herein.

As shown in FIG. 10, in the carrier 1 of the thermal sensor package M3 of the present embodiment, the base 10 and the side wall 11 are also not integrally formed, but are each made of a different material. In the present embodiment, the base 10 is made of ceramic, and the side wall 11 is made of metal. Further, the side wall 11 can be a pre-formed metal frame.

In the present embodiment, the side wall 11 has a top plate 11A and a wall 11B that extends from the top plate 11A towards the base 10. The top plate 11A has an opening 11h arranged on the top surface 110, and the opening 11h corresponds to the thermal sensor 3. The cover 4 is connected to the carrier 1, and is arranged at a position corresponding to the opening 11h. Further, the cover 4 is fixed to an inner side of the top plate 11A and closes the opening 11h, thereby enclosing the thermal sensor 3 and the IC 2 in the space H1.

In the manufacturing process of the thermal sensor package M3 of the present embodiment, the IC 2 and the thermal sensor 3 are sequentially disposed on the base 10, and then the side wall 11 is formed. Afterwards, the side wall 11 and the cover 4 that is fixed to the side wall 11 are jointly assembled to the base 10.

### Fourth Embodiment

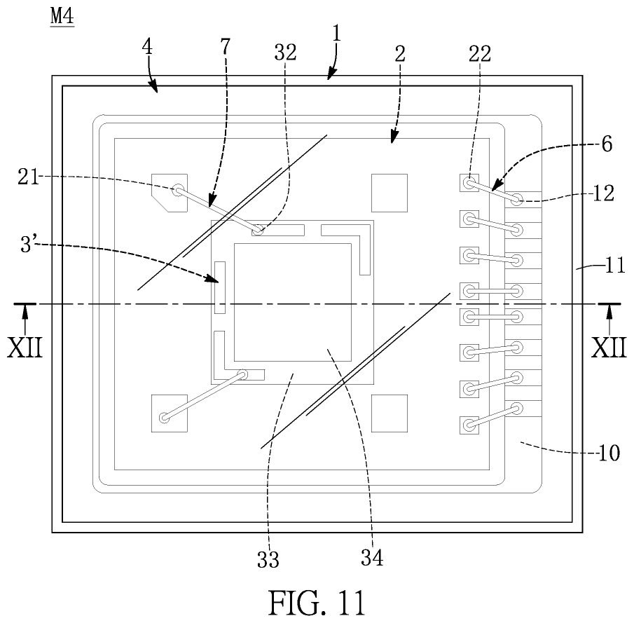

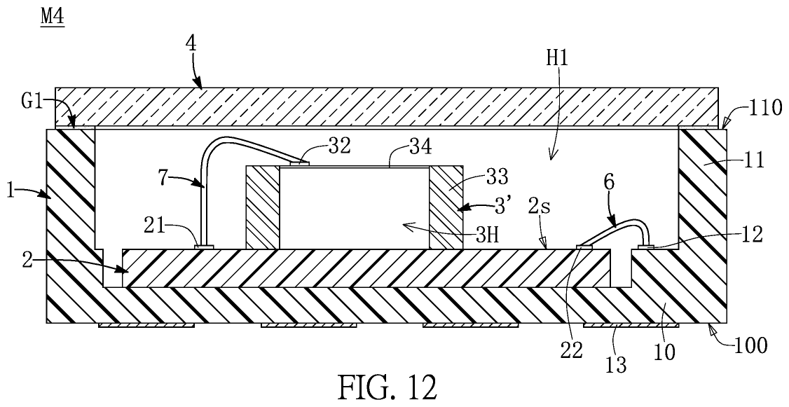

Referring to FIG. 11 to FIG. 13, FIG. 11 is a top view of a thermal sensor package according to a fourth embodiment of the present disclosure, and FIG. 12 is a cross-sectional view taken along line XII-XII of FIG. 11. In the present embodiment, components of a thermal sensor package M4 that are the same as or similar to those in the first to third embodiments have the same or similar markings, and the same components will not be reiterated herein.

As shown in FIG. 11, different from the thermal sensor 3 in the first to third embodiments described above, a thermal sensor 3′ of the present embodiment includes a plurality of pads 32, and the plurality of pads 32 are arranged on a side (i.e., a top side) of the thermal sensor 3′ that is away from the IC 2. In addition, in the present embodiment, the plurality of first connection pads 21 of the IC 2 are not arranged underneath the thermal sensor 3′, but are arranged on a periphery of the thermal sensor 3′. Accordingly, the thermal sensor package M4 further includes a plurality of connection wires 7, such that the plurality of pads 32 can be respectively and electrically connected to the plurality of first connection pads 21 through the plurality of connection wires 7.

In addition, a structure of the thermal sensor 3′ of the present embodiment is also different from a structure of the thermal sensor 3 of the first to third embodiments. For example, the thermal sensor 3′ of the present embodiment is a membrane thermal sensor.

Referring to FIG. 12, the thermal sensor 3′ has a frame 33 and a thermal sensing film 34. The frame 33 is made of, for example, silicon, and the frame 33 defines a cavity 3H. In addition, the thermal sensing film 34 is suspended above the IC 2 through the frame 33. Referring to FIG. 11 and FIG. 12, the thermal sensing film 34 covers the cavity 3H defined by the frame 33.

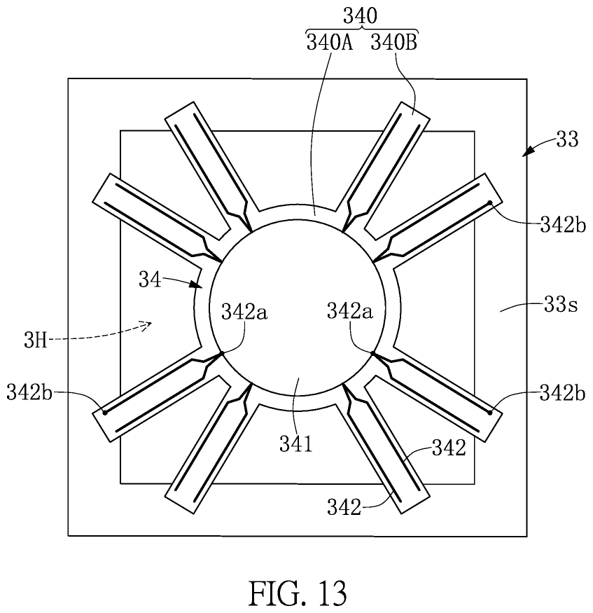

Referring to FIG. 13, FIG. 13 is a partial view of another embodiment of the thermal sensor. It should be noted that, a structure of the thermal sensing film 34 illustrated in FIG. 13 is merely an example, and is not meant to limit the scope of the present disclosure. In one particular embodiment, the thermal sensing film 34 includes a suspension support film 340, an infrared absorber 341, and a plurality of thermocouples 342. The suspension support film 340 is connected to a top surface 33s of the frame 33, and has an extremely high thermal impedance, so as to prevent rapid heat dissipation. The suspension support film 340 has a sensing area 340A and a plurality of bridging areas 340B that are correspondingly connected to the sensing area 340A and the frame 33. The plurality of bridging areas 340B extend radially from the sensing area 340A towards the top surface 33s of the frame 33.

The infrared absorber 341 is used for absorbing the thermal radiation (i.e., the infrared) from the object to be tested, and is formed in the sensing area 340A of the suspension support film 340. The plurality of thermocouples 342 are correspondingly arranged in the plurality of bridging areas 340B, so as to measure a temperature difference between the frame 33 and the infrared absorber 341. In the present embodiment, a hot junction 342a of each of the plurality of thermocouples 342 is connected to the infrared absorber 341, and a cold junction 342b of each of the plurality of thermocouples 342 is connected to the frame 33. Accordingly, when the infrared absorber 341 absorbs the thermal radiation (i.e., the infrared) from the object to be tested, a temperature of the infrared absorber 341 increases, and a difference between a temperature of the sensing area 340A of the suspension support film 340 and a temperature of the frame 33 is created, thereby causing a voltage difference between the hot junction 342a and the cold junction 342b of the thermocouple 342. In one particular embodiment, the plurality of thermocouples 342 can be connected in parallel with each other to form a thermopile, so as to enhance measurement sensitivity.

Accordingly, different from the first to third embodiments described above, the thermal sensor package M4 of the present embodiment does not necessarily include the adhesive 5. However, in another embodiment, the frame 33 can also be fixed to the IC 2 through a thermally conductive adhesive, so that the temperature of the frame 33 is close to the temperature of the IC 2. The aforementioned thermally conductive adhesive can be an insulating thermally conductive adhesive or an electrically and thermally conductive adhesive. When the thermally conductive adhesive is the insulating thermally conductive adhesive, a better protection can be provided to the surface of the IC 2.

### Beneficial Effects of the Embodiments

In conclusion, one of the beneficial effects of the present disclosure is that, in the thermal sensor package M1 to M4 provided by the present disclosure, by virtue of “the IC 2 being arranged in the space H1, and including the plurality of first connection pads 21” and “the thermal sensor 3, 3′ being stacked on the IC 2 and including the plurality of pads 31, 32, and the plurality of pads 31, 32 being respectively and electrically connected the plurality of first connection pads 21”, a size of an integrated package of the thermal sensor package M1 to M4 can be reduced, and a degree of integration of the integrated package can be enhanced.

Furthermore, the thermal sensor package M1 to M3 disclosed in the first to third embodiments also includes the adhesive 5 that has good thermal conductivity, which is filled into the gap g1 between the thermal sensor 3 and the IC 2, so as to improve the measurement accuracy of the thermal sensor package M1 to M3.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thermal sensor package, comprising:
a carrier defining an opening and a space;
an integrated circuit chip (IC) being accommodated in the space and including a plurality of first connection pads;
a thermal sensor stacked on the IC and being accommodated in the space, wherein the thermal sensor has a heat absorbing surface and a plurality of pads, wherein the heat absorbing surface is toward the opening and the plurality of pads are respectively and electrically connected to the plurality of first connection pads, so that the thermal sensor is electrically connected to the IC;
an adhesive disposed in the space, wherein at least one part of the adhesive is filled into a gap between the thermal sensor and the IC, and the adhesive does not cover the heat absorbing surface of the thermal sensor, wherein the adhesive is a material with thermally conductive and electrically insulating properties; and
a cover arranged at a position corresponding to the opening.

2. The thermal sensor package according to claim 1, wherein the adhesive completely covers the IC and partially covers a side surface of the thermal sensor, and a top surface of the adhesive is lower than or flush with the heat absorbing surface of the thermal sensor.

3. The thermal sensor package according to claim 1, wherein a thermal conductivity of the adhesive is greater than or equal to 1 W/m*K.

4. The thermal sensor package according to claim 1, wherein the carrier has:
a base; and
a side wall surroundingly arranged on the base and defining the opening, wherein the side wall and the base jointly define the space; wherein the cover is arranged at a position of the opening that is defined by the side wall.

5. The thermal sensor package according to claim 4, wherein the side wall has an engagement structure, the engagement structure is arranged on a top surface of the side wall, and the cover is disposed above the thermal sensor through the engagement structure.

6. The thermal sensor package according to claim 4, wherein the side wall has a top plate and a wall, the wall extends from the top plate towards the base, the top plate has the opening that corresponds to the thermal sensor, and the cover is fixed to an inner side of the top plate and closes the opening.

7. The thermal sensor package according to claim 4, wherein the carrier includes a plurality of internal contacts, the IC includes a plurality of second connection pads, and the plurality of second connection pads are electrically connected to the plurality of internal contacts respectively through a plurality of conducting wires; wherein, when the base has a recess or a stepped structure, the plurality of internal contacts are arranged on a top surface of the recess or the stepped structure, a height of the top surface of the recess or the stepped structure is similar to a height of the IC, and the plurality of conducting wires are embedded in the adhesive; wherein, when the base is a flat plate, the plurality of internal contacts are arranged on a surface of the flat plate, the side wall covers the plurality of internal contacts and the plurality of second connection pads, and the plurality of conducting wires are embedded in the side wall.

8. A thermal sensor package, comprising
a carrier defining an opening and a space;
an integrated circuit chip (IC) disposed in the space;
a thermal sensor electrically connected to and stacked on the IC, disposed in the space and having a sensing area for receiving thermal radiation entering through the opening, wherein the thermal sensor has a plurality of thermocouples connected in series or in parallel so as to measure a temperature difference between the sensing area of the thermal sensor and a surface of the IC; and
a cover arranged at a position corresponding to the opening.

9. The thermal sensor package according to claim 8, wherein the thermal sensor includes an infrared radiation absorbing layer, a thermopile layer, a protective layer, and a plurality of pads, the thermopile layer is arranged between the infrared radiation absorbing layer and the protective layer, and the plurality of pads and the protective layer are jointly arranged on a bottom side of the thermal sensor; wherein the thermopile layer includes the plurality of thermocouples, and each of the plurality of thermocouples includes a hot junction, a cold junction, a first pin assembly, and a second pin assembly; wherein the hot junction of one of the plurality of thermocouples and the cold junction of an adjacent one of the plurality of thermocouples are connected in series through at least one of the first pin assembly or the second pin assembly, and each of the first pin assembly and the second pin assembly includes a plurality of nanowire clusters.

10. The thermal sensor package according to claim 8, further comprising:
an adhesive used for keeping a temperature of a bottom surface of the thermal sensor close to a temperature of the IC;
wherein the adhesive is arranged only in a gap between the thermal sensor and the IC, or the adhesive fills the gap and covers a side surface of the thermal sensor, and a top surface of the adhesive is lower than or flush with a heat absorbing surface of the thermal sensor.

11. The thermal sensor package according to claim 10, wherein a thermal conductivity of the adhesive is greater than or equal to 1 W/m*K.

12. The thermal sensor package according to claim 8, wherein the cover is made of a material that allows infrared light within a wavelength range from 1 μm to 15 μm to pass through, and the material filters visible light.

13. The thermal sensor package according to claim 8, wherein the thermal sensor includes a frame and a thermal sensing film, the frame defines a cavity, and the thermal sensing film is arranged above the IC through the frame and covers the cavity; wherein the frame further has a plurality of pads arranged on a top surface of the frame and surround the thermal sensing film.

14. The thermal sensor package according to claim 13, wherein the thermal sensing film includes a suspension support film, an infrared absorber, and the plurality of thermocouples connected in parallel, a hot junction of each of the plurality of thermocouples is connected to the infrared absorber, and a cold junction of each of the plurality of thermocouples is connected to the frame, so that a difference between temperature detected by the hot junctions and temperature detected by the cold junctions is converted into a voltage signal or a current signal.

15. The thermal sensor package according to claim 13, wherein the IC has at least two first connection pads respectively and electrically connected to the at least two corresponding ones of the plurality of pads through at least two electrically conductive adhesives or at least two connection wires, respectively.

16. The thermal sensor package according to claim 8, wherein the carrier has:
a base; and
a side wall surroundingly arranged on the base and defining the opening, wherein the side wall and the base jointly define the space; wherein the cover is arranged at a position of the opening that is defined by the side wall.

17. The thermal sensor package according to claim 16, wherein the side wall has an engagement structure, the engagement structure is arranged on a top surface of the side wall, and the cover is disposed above the thermal sensor through the engagement structure.

18. The thermal sensor package according to claim 16, wherein the side wall includes a top plate and a wall, the wall extends from the top plate towards the base, the top plate has the opening corresponding to the thermal sensor, and the cover is fixed to an inner side of the top plate and closes the opening.

19. The thermal sensor package according to claim 16, wherein the base has a recess or a stepped structure and a plurality of internal contacts are arranged on a top surface of the recess or the stepped structure; wherein the IC includes a plurality of second connection pads electrically connected to the plurality of internal contacts respectively through a plurality of conducting wires.

20. The thermal sensor package according to claim 16, wherein the base is a flat plate and has a plurality of internal contacts arranged on a surface of the flat plate, and the side wall covers the plurality of internal contacts and partially covers a top surface of the IC.
